(19) United States
(12) Patent Application Publication
(10) Pub. No.: US 2005/0008408 A1
(43) Pub. Date: Jan. 13, 2005

(54) Fixing device and image forming apparatus

(75) Inventor: Toshiya Inomata, Kanagawa-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/885,975

(22) Filed: Jul. 8, 2004

(30) Foreign Application Priority Data
Jul. 11, 2003 (JP) 2003-195784
Jul. 11, 2003 (JP) 2003-195786
Jul. 11, 2003 (JP) 2003-195787
Jul. 11, 2003 (JP) 2003-196009

(51) Int. Cl. G03G 15/20

(52) U.S. Cl. 399/323

(57) ABSTRACT

A fixing device has a separation claw whose end portion is installed touchably with an outer periphery surface of a press roller. The separation claw makes the end portion make contact with the outer peripheral surface of the press roller, thereby separates a paper from the press roller. A rotation central shaft of the separation claw is rotatably supported by a support member and when force for pressing the end portion of the separation claw inside the press roller is given, the rotation central shaft of the separation claw is led so that the end portion of the separation claw is shifted in the direction of separating from the press roller.

### CROSS-REFERENCE TO RELATED APPLICATION

This application is based upon and claims the benefit of priority from the prior Japanese Patent Application No. 2003-195786 filed on Jul. 11, 2003, Japanese Patent Application No. 2003-196009 filed on Jul. 11, 2003, Japanese Patent Application No. 2003-195784 on Jul. 11, 2003 and Japanese Patent Application No. 2003-195787 file on Jul. 11, 2003; the entire contents of which are incorporated herein by reference.

### BACKGROUND OF THE INVENTION

1. Field of the Invention

The present invention relates to a fixing device used for an image forming apparatus for heating and pressing a toner image transferred to a sheet-like recording medium and fixing it to the recording medium.

2. Description of the Related Art

An image forming apparatus that transfers a toner image to a paper, fixes the toner image transferred to the paper by a fixing device, thereby forms an image on the paper is known.

As a fixing device installed in such an image forming apparatus, a one having a fixing roller for thermally fixing toner transferred to a transfer paper (recording paper), a press roller, a separation claw, and a spring is known. The separation claw is pressed by the spring so that the end portion thereof is pressed to the outer periphery of the fixing roller. On the main body side of the fixing device, a long guide groove for guiding and supporting the rotation central shaft of the separation claw is installed. The long guide groove is formed along the circumference coaxial with the outer periphery of the fixing roller. Further, on the main body side of the fixing device, a detection sensor for detecting movement of the rotation central shaft along the long guide groove is installed.

In this fixing device, as disclosed in Japanese Patent Application Publication 10-74015, when a jam occurs, the separation claw moves on the circumference coaxial with the outer periphery of the fixing roller along the long guide groove. When the separation claw moves, the detection sensor is turned on via a lever engaged with the rotation central shaft. By doing this, an occurrence of trouble (an occurrence of a jam) is detected.

Further, as a fixing device, in addition to it, as disclosed in Japanese Patent Application Publication No. 2000-264520, a one having a claw displacement means for moving the separation claw so as to separate the separation claw from the position in contact with the surface of the processing roller is known.

However, by the art disclosed in Japanese Patent Application Publication 10-74015, the separation claw moves on the circumference coaxial with the outer periphery of the fixing roller along the long guide groove. Namely, the separation claw moves along the outer periphery of the fixing roller so as not to separate from the outer periphery of the fixing roller. Therefore, to the end portion of the separation claw, by a jammed paper, force for pressing it inward the fixing roller may be input. In such a case, the end portion of the separation claw is pressed to the outer peripheral surface of the fixing roller, so that there is a fear of damaging the outer peripheral surface of the fixing roller.

Further, in recent years, the hardness of the outer periphery of the press roller has been lower (that is, softer) than before. Therefore, when the separation claw disclosed in Japanese Patent Application Publication 10-74015 is applied to a press roller the outer periphery of which is soft, if the end portion of the separation claw is pressed to the outer peripheral surface of the press roller by a jammed paper, the outer peripheral surface of the press roller is unpreferably damaged easily.

On the other hand, the art disclosed in Japanese Patent Application Publication No. 2000-264520 is structured so as to separate the separation claw from the surface of the processing roller by sliding the operation panel. Namely, unless an operator operates the operation panel, the separation claw does not separate from the processing roller. Therefore, the art is effective when removing a jammed paper after an occurrence of a jam, while when the jammed paper presses the separation claw against the processing roller, before removing the jammed paper, the separation claw may damage the processing roller.

Further, in a recent image forming apparatus, the transfer unit and fixing device are installed in the neighborhood of each other, thus miniaturization of the apparatus proceeds. By this miniaturization, the conveying distance between the transfer and fixing processes is shortened, thus a paper often extends over a plurality of processes.

Therefore, when a conveying fault of a paper (hereinafter referred to as a jam) occurs, particularly when a jam occurs in the fixing device, the jammed paper extends over a plurality of processes from the fixing device to the transfer unit and is held between a plurality of rollers.

At this time, the jammed paper clings closely onto the conveying surface between the fixing device and the transfer unit almost free of a gap. Therefore, a finger can be hardly inserted between the jammed paper and the conveying surface and it is difficult to remove the jammed paper.

Particularly when a jam occurs in the neighborhood of the fixing device, the conveying surface may become high in temperature due to heat generated from the heat roller and it is more difficult to remove the jammed paper.

Therefore, for an occurrence of a jam in the neighborhood of the fixing device, a method is developed for installing a rotation handle on each of the heat roller and press roller, rotating the heat roller and press roller by the rotation handles, thereby removing a paper held between the rollers.

Further, in recent years, for example, as disclosed in Japanese Patent Application Publication No. 7-157141, a method has been developed for when a jam occurs, staggering the timing for stopping the conveying of a paper in the transfer unit and fixing device, thereby forming bending in a part of the paper (the part of the paper separated from the conveying surface), holding the bent part, and removing the paper.

However, by the method for rotating the heat roller and press roller by the rotation handles, a paper must be held between the heat roller and the press roller and when it is not held, the paper cannot be removed even if the rotation handles are rotated.

Further, by the method for forming a bent part in a paper, the paper must extend over the distance between the transfer unit and the fixing device and when it does not, even if the timing for stopping the conveying of the transfer unit and fixing device is staggered, no bent part can be formed.

In recent years, as disclosed in Japanese Patent Application Publication No. 2003-76202, a belt fixing device having a fixing belt stretched between the heat roller and the separation roller has been proposed. In this kind of belt fixing device, by the heat roller and press roller in contact with each other in the pressed state across the belt, a paper with a toner image transferred to be heated in the pressed state to execute thermal fixing. Furthermore, the paper fixed in the belt fixing device is conveyed by the conveying belt stretched along the paper conveyor path. This paper is separated from the conveying belt by the separation roller. The separation roller portion is used as a separation point for separating the paper from the conveying belt, so that a satisfactory image forming result free of a claw mark can be obtained.

In the aforementioned belt fixing device, the relationship between the heat roller, the separation roller, the belt, and the press roller is important. For example, when a constitution that the belt fixing device applies driving force only to the heat roller and the separation roller, fixing belt, and press roller follow the heat roller is used, the separation roller is rotated by the heat roller via the fixing belt. In this case, if the separation roller and fixing belt slip, a fault occurs in driving of the fixing belt in the fixing device or conveying of the paper and as a result, there is the possibility that no satisfactory image quality can be obtained. Therefore, an art for driving efficiently and surely each unit in the belt fixing device is desired.

Further, in the aforementioned belt fixing device, the separation roller and heat roller support the fixing belt. Therefore, in the belt fixing device, when the relationship between the separation roller, the heat roller, and the fixing belt is not satisfactory, there is the possibility of an occurrence of a fault such as damage of the fixing belt. Therefore, an art for keeping the relationship between the fixing belt, the separation roller, and the heat roller satisfactory is desired.

Further, the fixing device, for example, as disclosed in Japanese Patent Application Publication No. 2000-112283, may have a separation member for separating a paper from the rotation member. As a separation member, a one having an upstream side separation end portion and a downstream side separation end portion is known. The upstream side separation end portion, to separate a paper passing a nip which is an area where the surface side rotation member in contact with the surface of the paper and the rear side rotation member in contact with the rear of the paper are pressed to each other from the surface side rotation member, is arranged on the upstream side of the downstream side separation end portion on the paper conveyor path and in contact with the surface side rotation member. The downstream side separation end portion, to surely separate the paper passing the nip from the surface side rotation member, is installed in contact with the fixing roller. The downstream side separation end portion is arranged for the purpose of preventing the paper from winding round the rotation member when a separation fault occurs.

Further, as a fixing device, for example, as disclosed in Japanese Patent Application Publication No. 5-307336, there is a one having a separation claw for separating a paper from the fixing roller available. The separation claw is generally linear and is composed of a support member having a rotation fulcrum for bending only the fixing roller side at the time of paper jamming and a claw end portion connected rotatably to the support member. In the separation claw, the rotation fulcrum of the support member is supported on the main body side and the claw end of the claw end portion is in contact with the fixing roller at a predetermined pressure. Further, in the claw end portion, on the side thereof on the fixing roller side, a lever member for at the time of paper jamming (when the support member is bent), making contact with the surface of the fixing roller and separating the claw end from the surface of the fixing roller by the lever action is installed.

On the other hand, the fixing device, in addition to the heat roller and the press roller for pressing the heat roller, may have a separation roller arranged opposite to the heat roller and a belt stretched between the heat roller and the separation roller. In such a fixing device, in the neighborhood of the top of the separation roller where the belt is stretched, the paper is separated. Further, in such a fixing device, for a case that the paper is adhered to the belt and cannot be separated, in the neighborhood of the top of the separation roller, a separation plate is arranged.

However, a very thin sheet material forms the separation plate with a thickness of about 0.3 mm, so that when a jam occurs and the jammed paper makes contact with the end face of the separation plate, the separation plate may be deformed or damaged.

An object of the present invention is to provide a fixing device capable of suppressing deformation and damage of the separation plate.

### SUMMARY OF THE INVENTION

An object of the present invention is to provide a fixing device capable of preventing rollers from scratching and damage.

Furthermore, an object of the present invention is to provide an image forming apparatus capable of, when a conveying fault of a paper occurs in the apparatus, simply removing the paper.

Further, another object of the present invention is to provide a fixing device capable of driving surely and efficiently each unit in the fixing device.

Furthermore, still another object of the present invention is to provide a fixing device capable of preventing a separation plate from deformation and damage.

According to the present invention, there is provided a fixing device comprising a heat roller whose outer peripheral surface is at least heated; a press roller configured to press the heat roller; at least one separation claw having a rotation central shaft provided at a first end portion thereof and a second end portion on the opposite of the first end portion, wherein the second end portion is provided touchably on an outer peripheral surface of either of the heat roller and the press roller, and the second end portion makes contact with the outer peripheral surface of the roller, thus the recording medium is separated from the roller; and a support member configured to rotatably support the rotation central shaft and lead the rotation central shaft to make the second end portion separate from the roller when pressing force is applied for the second end portion to make contact with the roller.

Furthermore, according to the present invention, there is provided an image forming apparatus to form an image on a surface of a paper conveyed in a conveyor path, comprising: a guide unit having a guide face to guide the paper; and a separation member that is provided in the guide unit projectably from the guide face, projects into the conveyor path from the guide face, thereby separates the paper from the guide face.

Further, according to the present invention, there is provided an image forming apparatus, comprising: a conveyor path configured to convey a paper on which an image is formed; and a rise and fall member for during conveying the paper, guiding the paper which is pushed down and conveyed in the conveyor path, and when the paper is jammed, is raised on a conveyor path side, thereby loosens the paper in the conveyor path.

Furthermore, according to the present invention, there is provided a fixing device, comprising: a heat roller heated by a heat source; a separation roller arranged in the neighborhood of the heat roller; a fixing belt supported in a state that the fixing belt is stretched between the heat roller and the separation roller; and a press roller in contact with the heat roller at a predetermined pressure across the fixing belt, wherein the heat roller is driven by driving means, and the separation roller, the fixing belt, and the press roller follow the heat roller driven by the driving means, and a surface of the separation roller is rougher than a contact face of the fixing belt.

Further, according to the present invention, there is provided A fixing device, comprising: a heat roller heated by a heat source; a separation roller arranged in the neighborhood of the heat roller; a fixing belt supported in a state that the fixing belt is stretched between the heat roller and the separation roller; and a press roller in contact with the heat roller at a predetermined pressure across the fixing belt, wherein a width of the separation roller is wider than a width of the fixing belt.

Furthermore, according to the present invention, there is provided a fixing device, comprising: a heat roller whose outer peripheral surface is at least heat ed; a press roller to press the heat roller; a separation roller arranged opposite to the heat roller; a fixing belt stretched between the heat roller and the separation roller; a support member provided rotatably in the neighborhood of the separation roller; and a separation plate which has an end surface and is supported by the support member so as to freely rotate between a proximity position w here the end surface approaches the fixing belt and a shift position where when the end surface is pressed, the end face is shifted so as to separate from the fixing belt farther than the proximity position.

### BRIEF DESCRIPTION OF THE DRAWINGS

FIG. 1 is a schematic diagram showing an image forming apparatus to which the fixing device of the present invention is applied;

FIG. 2 is a perspective view showing a part of the fixing device relating to the first embodiment of the present invention;

FIG. 3 is a perspective view showing the press roller of the fixing device shown in FIG. 2;

FIG. 4 is a side view showing the fixing device shown in FIG. 2;

FIG. 5 is a side view showing the fixing device when a jam occurs;

FIG. 6 is a perspective view showing the circumference of a guide unit arranged on the downstream side of the fixing device;

FIGS. 7A and 7B show the circumference of the guide unit, and FIG. 7A is a side view showing the state that the rise and fall member is pushed down, and FIG. 7B is a side view showing the state that the rise and fall member is raised;

FIGS. 8A and 8B show the situation when a paper jam occurs in the neighborhood of the guide unit, and FIG. 8A is a side view when the paper jam occurs, and FIG. 8B is a side view when the paper jam is removed;

FIG. 9 is a perspective view showing the fixing device relating to the second embodiment of the present invention;

FIG. 10 is a side view for explaining the pressing mechanism of a separation roller;

FIG. 11 is a side view for explaining the pressing mechanism of the separation roller;

FIG. 12 is a perspective view for explaining the pressing mechanism of the separation roller,

FIG. 13 is a perspective view for explaining the pressing mechanism of the separation roller;

FIG. 14 is a schematic view for explaining the relationship between the heat roller, the fixing belt, and the separation roller;

FIG. 15 is a perspective view showing the fixing device relating to the third embodiment of the present invention;

FIG. 16 is a side view showing the fixing device shown in FIG. 15; and

FIG. 17 is a side view showing the fixing device shown in FIG. 15, which is partially enlarged.

### DETAILED DESCRIPTION OF THE INVENTION

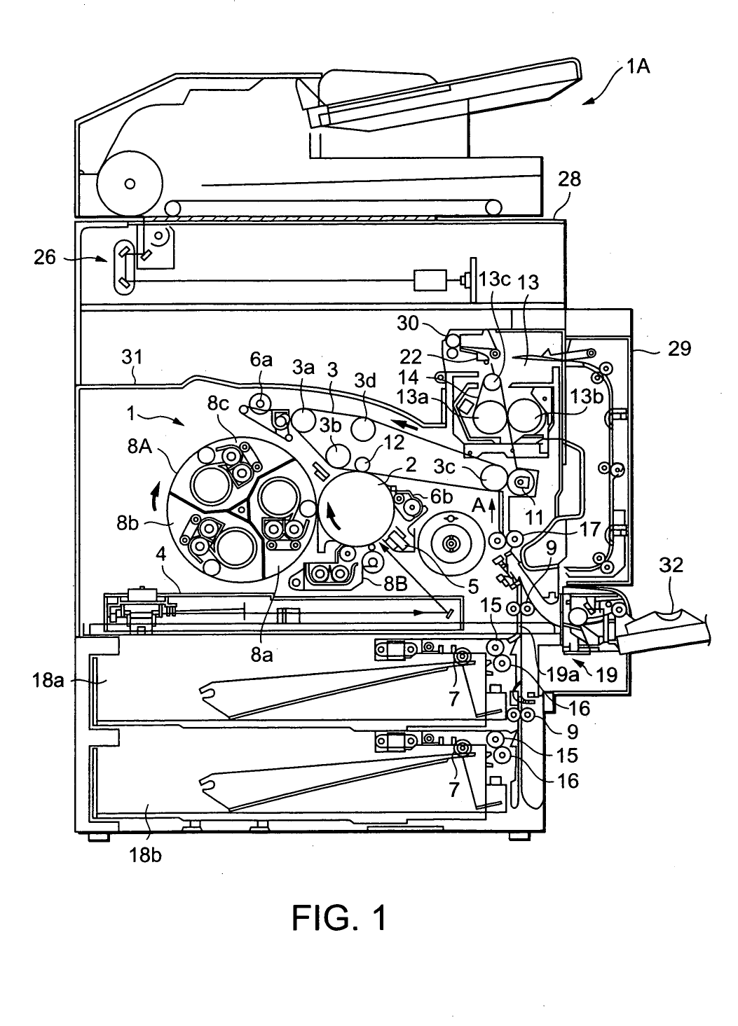

The first embodiment of the fixing device of the present invention will be explained below with reference to FIGS. 1 to 4.

Firstly, an electro-photographic copier as an image forming apparatus having built-in fixing device 1 of the present invention will be explained. The electro-photographic copier has main body 1A and in main body 1A, image forming unit 1 is installed. Image forming unit 1 has photosensitive drum 2, main charger 5 for charging photosensitive drum 2 at a predetermined potential, and exposure unit 4 for forming an electrostatic latent image on charged photosensitive drum 2.

Image forming unit 1 has rotary developing device 8A for color for feeding and visualizing toner as a developer to the electrostatic latent image formed on photosensitive drum 2 by exposure unit 4 and static developing device 8B for monochrome. Rotary developing device 8A has first developing unit 8a for feeding yellow toner, second developing unit 8b for feeding cyan toner, and third developing unit 8c for feeding magenta toner.

Image forming unit 1 has intermediate transferring belt 3 for temporarily holding a toner image formed on photosensitive drum 2 by developing units 8A and 8B. Image forming unit 1 has cleaner 6a for cleaning intermediate transferring belt 3 and cleaner 6b for removing residual toner on photosensitive drum 2.

Intermediate transferring belt 3 is stretched between first to fourth rollers 3a to 3d at a predetermined tension and to the part thereof stretched between second and third rollers 3b and 3c, the outer peripheral surface of photosensitive drum 2 clings closely. To the top of photosensitive drum 2, primary transferring roller 12 is pressed via intermediate transferring belt 3.

Under image forming unit 1, paper supply cassettes 18a and 18b for setting papers P of predetermined size are installed. On paper supply cassettes 18a and 18b, pick-up rollers 7 are installed respectively. Papers P taken out by pick-up rollers 7 are separated one by one by paper supply roller 15 and separation roller 16 and are conveyed by conveying unit 19.

On conveying unit 19, sequentially in the conveying direction (refer to arrow A shown in FIG. 1) of paper P, conveying roller pair 9, aligning roller 17, secondary transferring roller 11, and exit roller pair 30 are installed and conveyor path 19a for conveying papers P by rollers 9, 11, 17, and 30 is formed. Aligning roller 17 temporarily stops conveyed paper P and corrects the inclination of paper P to the conveying direction so as to coincide the end of paper P with the end of a toner image on intermediate transferring belt 3.

Between secondary transferring roller 11 and exit roller pair 30, fixing device 13 for fixing a toner image transferred to paper P by heating is installed. Fixing device 13 has heat roller 13a and press roller 13b. On the downstream side of heat roller 13a in the conveying direction of paper P, separation roller 13c is arranged. Between heat roller 13a and separation roller 13c, fixing belt 14 is stretched. Fixing belt 14 circulates between rollers 13a and 13b by rotating separation roller 13c.

Press roller 13b is pressed against the outer peripheral surface of heat roller 13a and presses paper P conveyed between rollers 13a and 13b to heat roller 13a.

On the downstream side of separation plate 20 in the conveying direction of paper P, guide unit 22 for guiding paper P separated from fixing belt 14 by separation plate 20 to exit roller pair 30 is installed.

On the downstream side of exit roller pair 30 in the conveying direction of paper P, receiving tray 31 for receiving ejected paper P is installed.

On one side of main body 1A, automatic duplex device 29 used at the time of double-side copy and manual paper supply unit 32 used at the time of manual paper supply are installed.

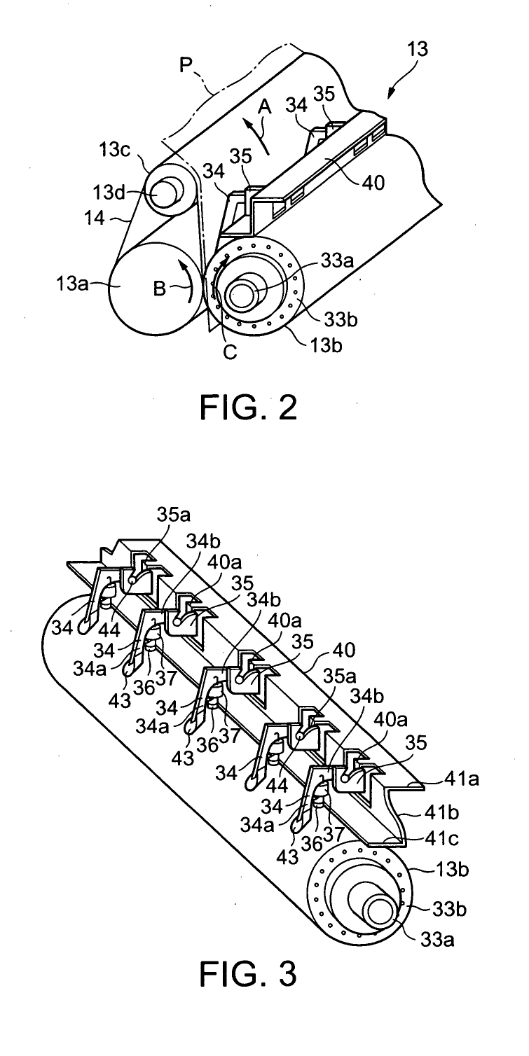

Fixing device 13 shown in FIG. 2 has the electro-photographic copier shown in FIG. 1. Fixing device 13 lets paper P as a sheet-like recording medium to which a toner image is transferred between heat roller 13a and press roller 13c pass, thereby fixes the toner image on paper P.

Fixing device 13 of this embodiment is composed of heat roller 13a whose outer peripheral surface is at least heated, separation roller 13c for separating paper P, fixing belt 14 stretched between heat roller 13a and separation roller 13c, press roller 13b for pressing heat roller 13a, separation claw 32 for separating paper P from press roller 13b, support member 35 for supporting separation claw 34, stopper 36 for suppressing end portion 43 of separation claw 34 from passing a predetermined position and moving in the direction of pressing inside press roller 13b, press spring 37 as a pressing means for pressing separation claw 34 in the direction that end portion 43 of separation claw 34 makes contact with the outer peripheral surface of press roller 13b, and fixing member 40 for fixing support member 35.

As heat roller 13a, for example, a one which is structured so that a heater lamp is inserted as a heat source in a cylindrical member or the outer peripheral surface of the cylindrical member is heated by IH (induction heating) may be used. Heat roller 13a is rotated by a rotation driving unit not shown in the drawing in the direction of arrow B shown in the drawing.

Separation roller 13c is arranged in the neighborhood of heat roller 13a. In this embodiment, separation roller 13c is arranged, for example, above heat roller 13a. From both ends of separation roller 13c, shafts 13d (only shaft 13d extending from one end is shown in the drawing) are extended and shafts 13d are born rotatably by bearings not shown in the drawing. Between separation roller 13c and heat roller 13a, fixing belt 14 is stretched. The rotation of heat roller 13a is transferred to separation roller 13c via fixing belt 14, so that separation roller 13c follows the rotation of heat roller 13a.

Press roller 13b has rotary shaft 33a and elastic member 33b installed so as to cover the outer periphery of rotary shaft 33a. Elastic member 33b may use, for example, a sponge made of synthetic resin. The hardness of elastic member 33b is set to ASKER C 55 or lower (55 degrees or lower) in the standard name of SRISO101, test kind, spring type ASKER C.

Press roller 13b is installed so as to press heat roller 13a. Rotary shaft 33a is born rotatably by a bearing not shown in the drawing. Press roller 13b is rotated by a rotation driving unit not shown in the drawing in the direction of arrow C shown in the drawing, that is, in the opposite direction of the rotational direction of heat roller 13a.

One to, for example, five separation claws 34 are installed. In this embodiment, five separation claws are arranged side by side so as to be separated from each other in the longitudinal direction of press roller 13b (refer to FIG. 3). Support member 35, stopper 36, and press spring 37 are installed respectively in correspondence with separation claw 34. In this embodiment, five support members 35, stoppers 36, and press springs 37 are installed so as to correspond to separation claws 34 one to one. Support members 35, stoppers 36, and press springs 37 are installed on fixing member 40.

Fixing member 40 is arranged in the neighborhood of press roller 13b. In this embodiment, fixing member 40 is arranged, for example, above press roller 13b.

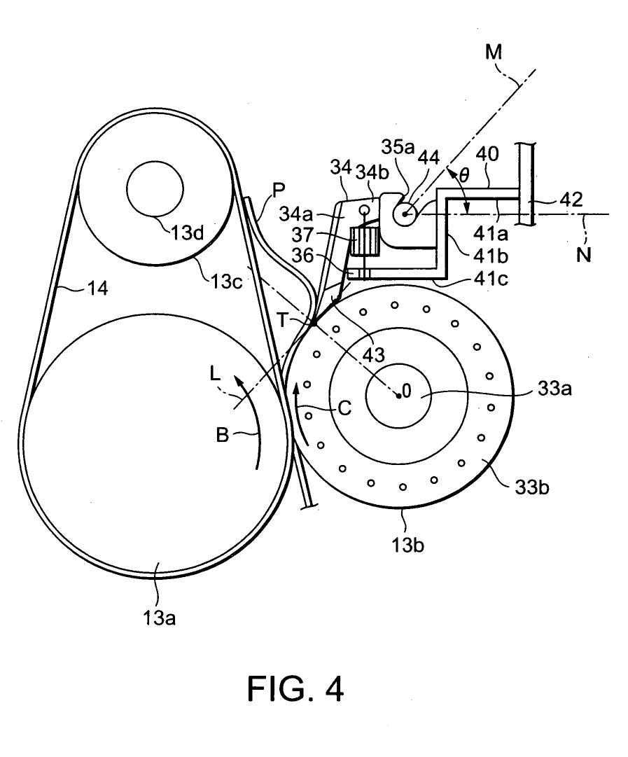

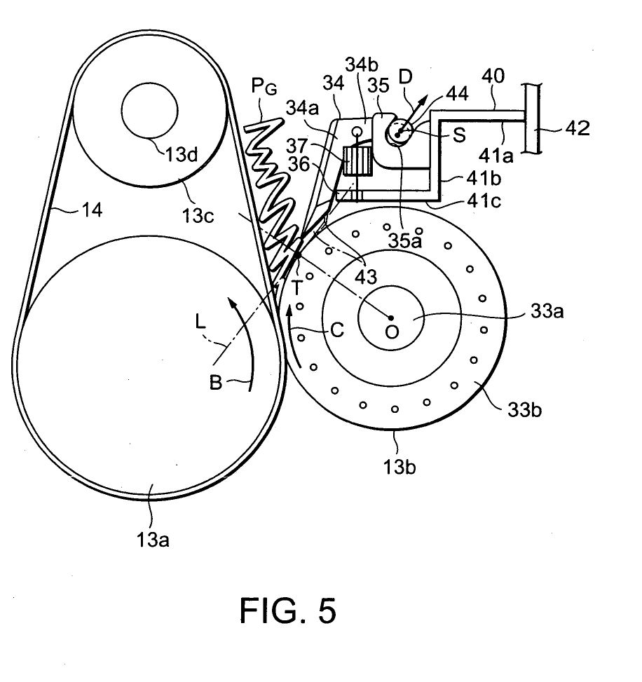

Fixing member 40 is formed in a long and narrow shape in the longitudinal direction of press roller 13b and is fixed to, for example, the outer wall (refer to FIGS. 4 and 5) of stay 42 for supporting fixing device 13. Fixing member 40 has first projecting wall 41a projecting almost horizontally toward press roller 13b from stay 42, side-wall 41b bent almost perpendicularly downward so that the end side of first projecting wall 41a approaches press roller 13b, and second projecting wall 41c projecting almost horizontally toward heat roller 13a from side-wall 41b.

On sidewall 41b, five fixing portions 40a for fixing support members 35 in the longitudinal direction are installed so as to be separated from each other. From the edge of second projecting wall 41c, respectively in correspondence with fixing portions 40a, stoppers 36 are projected horizontally toward heat roller 13a. In this embodiment, stoppers 36 are formed integrally with fixing member 40. However, stoppers 36 and fixing member 40 may be formed separately.

Each separation claw 34 has long side 34a and short side 34b. In this embodiment, the angle formed by each long side 34a and each short side 34b is an obtuse angle. End portion 43 of each separation claw 34, that is, the end portion of each long side 34a is formed in a knife-edge shape. From the other end portion of each separation claw 34, that is, both sides of the end portion of each short side 34b, rotation central shafts 44 are projected.

Each support member 35 has grooved notch portion 35a for hooking and supporting rotation central shaft 44 of each separation claw 34. In this embodiment, each support member 35 is notched so as to be opened in the direction of straight line M parallel with tangent L passing center S of each rotation central shaft 44 and passing point of tangency T of end portion 43 of each separation claw 34 and the outer peripheral surface of press roller 13b and on the opposite side of heat roller 13a, thus each notch portion 35a is formed. When each notch portion 35a is hooked by rotation central shaft 44 of each separation claw 34, support member 7 supports separation claw 34 rotatably. Each separation claw 34 just hooks notch portion 35a of each support member 35 by rotation central shaft 44. Therefore, each separation claw 34 can move along each notch portion 35a, that is, can make contact with and remove from the outer peripheral surface of press roller 13b.

When force for pressing inward press roller 13b is given to end portion 43 of each separation claw 34, the separation claw 34 moves inward press roller 13b. Therefore, in this embodiment, between long side 34a of each separation claw 34 and second projecting wall 41c of fixing member 40, stopper 36 is installed. By a reaction from each stopper 36 generated when each separation claw 34 makes contact with stopper 36, to move separation claw 34 in the direction of separating from press roller 13b, the positions and shapes of separation claw 34 and stopper 36 are respectively set. One end of each press spring 37 is engaged with short side 34b of each separation claw 34 and the other end is engaged with each stopper 36. Therefore, in the ordinary state, end portion 43 of each separation claw 34 is pressed by each press spring 37 and makes contact with the outer peripheral surface of press roller 13b.

When force for pressing inward press roller 13b is given to end portion 43 of each separation claw 34, the separation claw 34 operates as indicated below.

When force for pressing inward press roller 13b is given to end portion 43 of each separation claw 34, the separation claw 34 moves toward corresponding stopper 36 and long side 34a makes contact with the stopper 36. Therefore, to the separation claw 34, a reaction from the stopper 36 is given. However, the movement direction of rotation central shaft 44 of each separation claw 34 is restricted by corresponding notch portion 35a, so that rotation central shaft 44 moves in the direction along notch portion 35a instead of the direction in which stopper 36 reacts.

In this embodiment, each notch portion 35a is open in the direction of straight line M, that is, in the direction of separating from heat roller 23a, so that the movable direction of center S of each rotation central shaft 44 is the direction of straight line M and the direction of separating from heat roller 13a. Therefore, by the component of the reaction from stopper 36, rotation central shaft 44 of separation claw 34 makes contact with notch portion 35a and is led, and moves in the direction in which end portion 43 of separation claw 34 is separated from press roller 13b.

On the other hand, when end portion 43 of each separation claw 34 is to be shifted in the direction of separating from press roller 13b, the movement position of center S of corresponding rotation central shaft 44 is preferably set on straight line M parallel with tangent L passing center S of rotation central shaft 44 and passing point of tangency T of end portion 43 of separation claw 34 and the outer peripheral surface of press roller 13b, or on horizontal line N passing center S of rotation central shaft 44, or within range of θheld by straight line M and horizontal line N and more preferably in the direction of straight line M. By doing this, the end of separation claw 34 can move in the direction of separating from press roller 13b. Therefore, the direction of corresponding notch portion 35a is preferably set within range θheld by straight line M and horizontal line N and more preferably set on straight line M.

The fixing device structured as mentioned above operates as indicated below. Heat roller 13a rotates in the direction of arrow B shown in the drawing and press roller 13b rotates in the direction of arrow C shown in the drawing. Therefore, paper P led from underneath between heat roller 13a and press roller 13b for pressing heat roller 13a is conveyed upward as shown by arrow A in FIG. 2. And, paper P led to fixing belt 14 and conveyed to separation roller 13c is separated from fixing belt 14 in the neighborhood of the top of separation roller 13c (refer to FIG. 2). And, it is led to a conveying mechanism not shown in the drawing and is ejected.

On the other hand, paper P is generally conveyed as mentioned above, though it may be adhered to press roller 13b and conveyed so as to be wound round press roller 13b. Also in such a case, separation claw 34 forces its way between paper P and press roller 13b and separates paper P from press roller 13b, so that paper P can be returned again to the ordinary conveyor path (refer to FIG. 4).

On the other hand, when a jam or paper clogging occurs and jammed paper P_{G} presses end portion 43 of separation claw 34 so as to press it inside press roller 13b, separation claw 34 is pressed by jammed paper P_{G} and moves in the direction of making contact with stopper 36. Separation claw 34 pressed by jammed paper P_{G} is led to notch portion 35a by the component of the reaction from stopper 36 and moves in the direction of arrow D shown in FIG. 5, that is, in the direction of straight line M (FIG. 4) and in the direction of separating from heat roller 13a. Therefore, end portion 43 of separation claw 34 is separated from heat roller 13a without being pierced into heat roller 13a.

Further, when jammed paper P_{G} is removed, separation claw 34 is returned to its ordinary position (refer to FIG. 4) by press spring 37.

As mentioned above, according to fixing device 13 of this embodiment, since it has separation claw 34, paper P which is adhered to press roller 13b and conveyed so as to be wound round press roller 13b can be separated from press roller 13b. Moreover, even when end portion 43 of separation claw 34 is pressed by the outer peripheral surface of press roller 13b by jammed paper P_{G}, separation claw 34 leads rotation central shaft 44 to support member 35 and shifts so as to separate end portion 43 from the outer peripheral surface of press roller 13b, so that press roller 13b can be prevented from damage and scratching.

A plurality of separation claws 34 are installed and are supported by support members 35 so as to operate independently of each other, so that paper P can be separated satisfactorily from press roller 13b. Further, only separation claw 34 pressed to the outer peripheral surface of press roller 13b by jammed paper P_{G} can be shifted so as to separate from press roller 13b.

Fixing device 13 of this embodiment, when the hardness of the outer periphery of press roller 13b is ASKER C 55 or lower in the SRISO101 spring type ASKER C type, is particularly effective and even if the outer periphery of press roller 13b is comparatively soft like this, the outer periphery of press roller 13b can be prevented from damage by separation claw 34.

Furthermore, fixing device 13 of this embodiment has stopper 36 for suppressing end portion 43 of separation claw 34 from passing a predetermined position and moving in the direction of pressing inside press roller 13b, so that end portion 43 of separation claw 34 can be prevented from passing the predetermined position and being pressed inside press roller 13b. Moreover, by a reaction from stopper 36 generated when separation claw 34 makes contact with stopper 36, to move separation claw 34 in the direction of separating from press roller 13b, the positions and shapes of separation claw 34 and stopper 36 are respectively set. Therefore, when force to press end portion 43 of separation claw 34 inward press roller 13b is given to separation claw 34, end portion 43 of separation claw 34 can be separated from press roller 13b.

Furthermore, when end portion 43 of separation claw 34 is to be shifted in the direction of separating from press roller 13b, the movement position of center S of rotation central shaft 44 is set on straight line M parallel with tangent L passing center S of rotation central shaft 44 and passing point of tangency T of end portion 43 of separation claw 34 and the outer peripheral surface of press roller 13b, or on horizontal line N passing center S of rotation central shaft 44, or within the range held by straight line M parallel with tangent L passing pint of tangency T and horizontal line N. Therefore, unless end portion 43 of separation claw 34 is pierced into heat roller 13a, end portion 43 can be separated from heat roller 13a.

Further, the number of separation claws 34 may be set to one or more. Further, in this embodiment, separation claw 34 is installed touchably on the outer peripheral surface of press roller 13b. However, separation claw 34 may be installed touchably on the outer peripheral surfaces of heat roller 13a and separation roller 13c. Furthermore, when a plurality of separation claws 34 are installed, separation claws 34 may be installed in correspondence with a plurality of rollers among press roller 13b, heat roller 13a, and separation roller 13c. Further, separation roller 13c and fixing belt 14 may be omitted.

Further, in this embodiment, the plurality of separation claws 34 are supported by support members 35 so as to operate independently of each other. However, the plurality of separation claws 34 may be mutually connected, thereby may operate in connection with each other. Support members 35 and separation claws 34 may not have a one-to-one correspondence with each other and one support member 35 may support a plurality of separation claws 34.

Furthermore, the movement direction of separation claws 34 is not limited to the direction parallel with the tangent passing the point of tangency between end portions 43 of separation claws 34 and the outer peripheral surfaces of the rollers (press roller 13b, heat roller 13a, and separation roller 13c) and any direction in which end portions 43 of separation claws 34 are separated from the rollers is acceptable. Further, stoppers 36 and press springs 37 as pressing means may be omitted.

Next, the constitution of fixing device 13, guide unit 22 for guiding conveying of paper P passing fixing device 13, and circumference thereof will be explained.

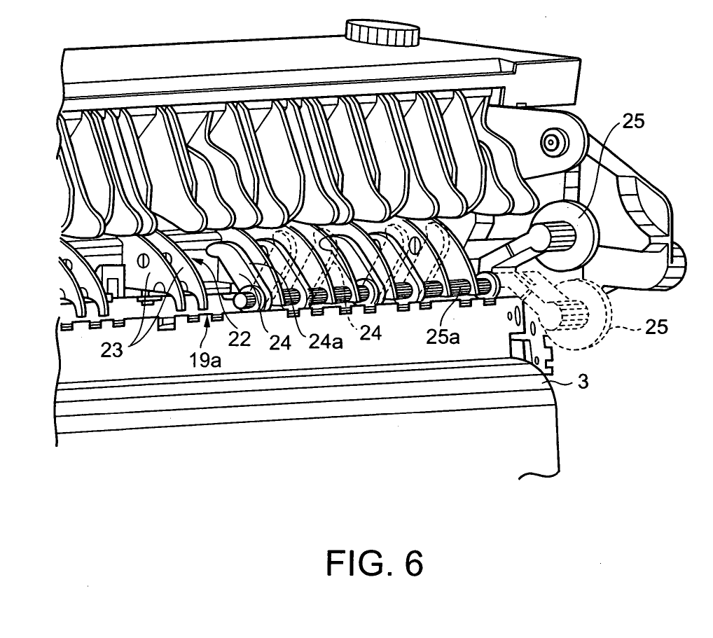

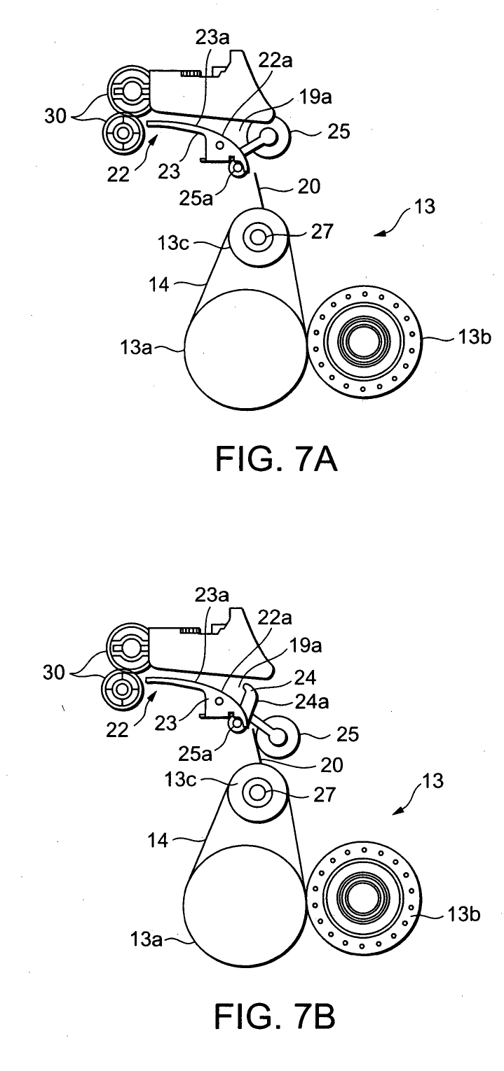

FIG. 6 is a perspective view showing the circumference of guide unit 22, and FIGS. 7A and 7B are schematic side views showing the circumference of guide unit 22, and FIG. 7A shows the state that rise and fall member 24 is pushed down, and FIG. 7B shows the state that rise and fall member 24 is raised.

As shown in FIGS. 6, 7A, and 7B, fixing device 13 has heat roller 13a and press roller 13b. On the downstream side of heat roller 13a in the conveying direction of paper P, separation roller 13c is arranged. Between heat roller 13a and separation roller 13c, fixing belt 14 is stretched. Fixing belt 14 rotates separation roller 13c, thereby circulates between rollers 13a and 13c.

Separation roller 13c has a built-in heating unit (not shown in the drawing). When the heating unit is operated, fixing belt 14 can be heated up to about 200° C. via separation roller 13c. Press roller 13b is pressed to the outer peripheral surface of heat roller 13a and paper P conveyed between rollers 13a and 13b is pressed to heat roller 13a.

On the downstream side of heat roller 13c in the conveying direction of paper P, separation plate 20 is arranged. One end portion of separation plate 20 thrusts with a slight gap against the outer peripheral surface of separation roller 13c, thus paper P ejected from fixing device 13 can be separated from fixing belt 14.

On the downstream side of separation plate 20 in the conveying direction of paper P, guide unit 22 for guiding paper P separated from fixing belt 14 by separation plate 20 to exit roller pair 30 is installed.

Guide unit 22 is structured so as to install a plurality of guide plates 23 side by side at predetermined intervals. Each guide plate 23 has curved surface 23a curved at a predetermined curvature and since the guide plates are installed side by side, guide face 22a smoothly curved by each curved surface 23a is formed. Paper P ejected from fixing device 13 is smoothly guided toward exit roller pair 30 in the close contact with guide face 22a. Further, the curvature centers of curved surface 23a and guide face 22a are positioned on the opposite side of conveyor path 19a across curved surface 23a and guide face 22a.

On the part of guide unit 22 on the upstream side of paper P in the conveying direction, shaft member 25a composed of a round bar is installed almost perpendicularly to each guide plate 23 and rotatably. On shaft member 25a, a plurality of rise and fall members 24 (separation members), wherein one end face 24a is formed in a shape along guide face 22a, are installed at predetermined intervals. Rise and fall members 24 are made of resin and each of them is arranged in the gap between guide plate 23 and guide plate 23.

At one end portion of shaft member 25a, lever 25 is fixed. When lever 25 is held and shaft member 25a is rotated, guide plate 23 can rise and fall.

When rise and fall member 24 is pushed down by lever 25, rise and fall member 24 is completely stored in the gap between guide plates 23 (indicated by a solid line in FIG. 6). Further, when rise and fall member 25 is raised by lever 25, rise and fall member 24 is projected into conveyor path 19a from guide face 22b (indicated by a dotted line in FIG. 6).

Next, the operation of the aforementioned electro-photographic copier will be explained.

Firstly, optical image reader 26 reads a document loaded on document table 28. At this time, the surface of photosensitive drum 2 is evenly charged by main charger 5. And, the charged photosensitive drum 2 is exposed by exposure unit 4 according to read information and an electrostatic latent image is formed. The electrostatic latent image is sent to and faces developing unit 8B by rotation of photosensitive drum 2, is supplied with black toner from developing unit 8B, and is developed. The developed toner image is sent onto intermediate transfer belt 3 by the rotation of photosensitive drum 2 and is primarily transferred by primary transferring roller 12. After passing the transfer area, photosensitive drum 2 is discharged by a discharger (not shown in the drawing). The toner remaining on photosensitive drum 2 is cleaned by cleaner 6b.

At this time, paper P taken out from paper supply cassettes 18a and 18b is sent between intermediate transfer belt 3 and secondary transfer roller 11 and the toner image on intermediate transfer belt 3 is secondarily transferred onto paper P. After transfer, paper P is separated from intermediate transfer belt 3 and is sent to fixing device 13 and the toner image is fixed by fixing device 13 by heating and pressurizing. After fixing, paper P is guided by guide unit 22 and is ejected to the outside by exit roller pair 30. Paper P ejected to the outside is sequentially loaded on receiving tray 31. At this time, rise and fall member 24 is pushed down and is stored in the gap between guide plates 23. By doing this, conveying of paper P will not be obstructed by rise and fall member 24.

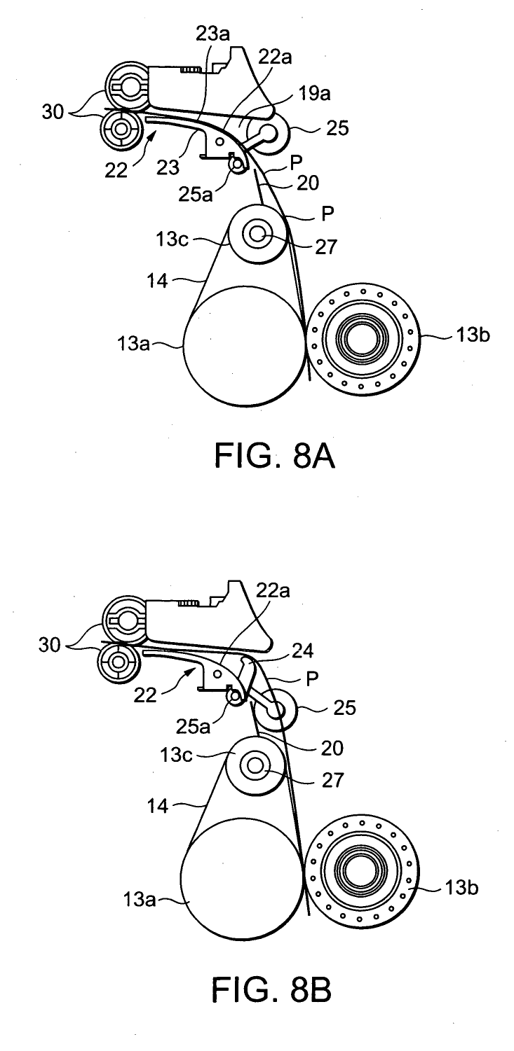

When a jam occurs by paper P in the neighborhood of fixing device 13, particularly when jammed paper P is held between fixing device 13 and exit roller pair 30, since guide face 22a is curved, as shown in FIG. 8A, paper P may be adhered closely to guide face 22a almost with no space.

In this case, it is difficult to insert a finger between guide face 22a and paper P, so that it is very difficult to remove jammed paper P. However, as shown in FIG. 8B, when lever 25 is rotated and rise and fall member 24 is raised for guide face 22a, jammed paper P can be separated from guide face 22a. By this separation, a space can be formed between guide face 22a and paper P. A finger is inserted into the space, thus jammed paper P can be easily removed.

By doing this, an operator can remove jammed paper P without touching guide unit 22 with a finger. Therefore, even if guide face 22a is at high temperature by heating by fixing device 13, jammed paper P can be removed fearlessly and quickly.

Furthermore, to separate jammed paper P from guide face 22a using rise and fall member 24, a space for inserting a finger can be formed at a fixed position. As a result, jammed paper P can be removed surely.

According to this embodiment, even if jammed paper P is held only by either of fixing device 13 and exit roller pair 30, a space can be formed between guide face 22a and jammed paper P.

Further, after removal of jammed paper P, when lever 25 is rotated and rise and fall member 24 is stored in the gap between guide plates 23, the copy operation can be restarted immediately.

One end face 24a of each rise and fall member 24 is formed in almost the same shape as that of curved surface 23a of each guide plate 23. Each rise and fall member 24 is positioned so that end face 24a is flush with guide face 22a. By doing this, guide face 22a is composed of curved surface 23a of each guide plate 23 and end face 24a of each rise and fall member 24. Therefore, compared with a case of only guide plates 23, the area for supporting paper P is increased and paper P can be guided more surely.

In the aforementioned embodiment, rise and fall member 24 is installed in guide unit 22 having guide face 22a smoothly curved. However, even if rise and fall member 24 is installed, for example, in a guide unit having a guide face in an almost plane shape, a jammed paper can be removed quickly and surely. As such a part, between fixing device 13 and secondary transferring roller 11 or between conveying roller pair 9 and paper supply roller 15 may be considered.

By increasing the number of rise and fall members 24, guide unit 22 can be omitted. Namely, when the copy operation is to be performed, rise and fall member 24 is pushed down and only by end face 24a thereof, guide face 22A for guiding paper P is formed. When a paper jam occurs, rise and fall member 24 may be raised and jammed paper may be loosened in conveyor path 19a.

A rise and fall mechanism is installed in guide unit 22, and guide unit 22 rises and falls, thereby may be used as a guide during the copy operation, and when a paper jam occurs, paper P may be loosened.

Next, the second embodiment of the fixing device of the present invention will be explained.

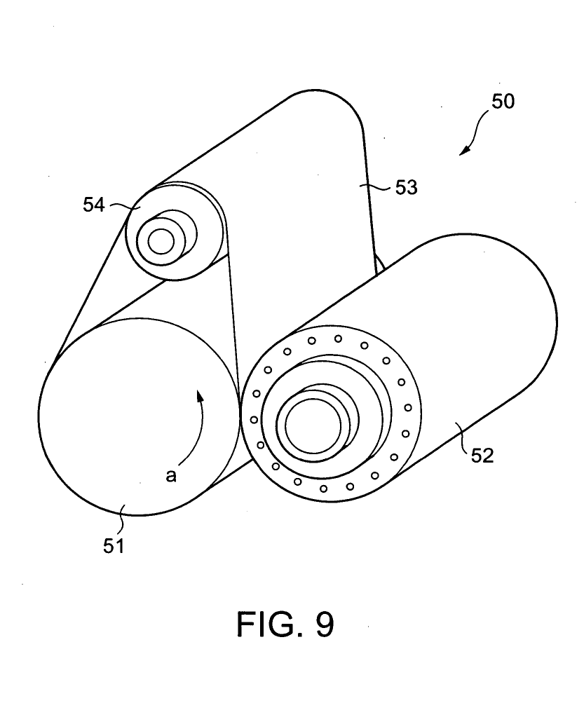

In FIG. 9, fixing device 50 is composed of heat roller 51, press roller 52, fixing belt 53, and separation roller 54.

Heat roller 51 is driven to rotate in the direction of a (to right) 15 shown in the drawing by a drive motor not shown in the drawing as a driving means. Heat roller 51 has a built-in heat source. By the heat source, the surface of heat roller 51 is heated to the fixing temperature. As a heat source for heat roller 51, a heating element such as an IH coil or a halogen lamp is used.

For example, when an IH coil is used as a heat source for heat roller 51, in heat roller 51, a conductive material, for example, iron is formed in a cylindrical shape and moreover, the outer peripheral surface of the iron is coated with, for example, fluorine plastics such as 4-ethylene fluoride plastics. Further, when an IH coil is used as a heat source, the IH coil is given high frequency power and generates a high frequency magnetic field for induction heating. When the high frequency magnetic field is generated, an eddy current is generated in heat roller 51 and heat roller 51 itself generates heat by Joule heat due to the eddy current.

Between heat roller 51 and separation roller 54, fixing belt 53 is stretched. Fixing belt 53 must efficiently conduct heat from heat roller 51 and for example, so that it is formed by a metal such as nickel. Particularly when an IH coil is used as a heat source for heat roller 51, heat from heat roller 51 must be efficiently given to fixing belt 53, so that fixing belt 53 is preferably formed by a metal.

To separation roller 54, by a pressing mechanism that will be described later, force is applied in the direction of separating from heat roller 51. On the other hand, the shaft of heat roller 51 is fixed. Therefore, fixing belt 53 is stretched at a predetermined pressure applied to separation roller 54 from the pressing mechanism. Namely, the force applied to fixing belt 53 is force given by the pressing mechanism in the direction of separating separation roller 54 from heat roller 51.

The driving force of heating roller 51 is transmitted to separation roller 54 by fixing belt 53. Namely, separation roller 54 follows heat roller 51 by fixing belt 53.

Press roller 52, by the pressing mechanism not shown in the drawing, is pressed to heat roller 51 at a predetermined pressure (for example, about 20 kg) across fixing belt 53. The surface of press roller 52 is composed of, for example, a heat-resistant elastic member such as sponge or rubber. Therefore, press roller 52 is in contact with the peripheral surface of fixing belt 53 in the pressurized state at the position opposite to heat roller 51. The contact portion of press roller 52 and fixing belt 53 is structured so as to have a fixed nip width.

The driving force of heat roller 51 is transmitted also to press roller 52 via fixing belt 53 and press roller 52 also follows heat roller 51. Namely, fixing device 50 is structured so that only heat roller 51 is driven by the driving means and press roller 52, fixing belt 53, and separation roller 54 follow heat roller 51.

In fixing device 50, a paper as an image formed medium with a toner image transferred is supplied to the nip portion of press roller 52 and fixing belt 53. The nip portion, when heat from heat roller 51 is given to the paper with a toner image transferred, is pressurized at a predetermined pressure. By doing this, the toner on the paper as an image formed medium is melted and fixed on the paper.

Separation roller 54 is installed to separate the paper fixed by press roller 52, fixing belt 53, and the nip portion from fixing belt 53. Separation roller 54 separates the paper by the curved surface thereof. Further, a paper that is not separated even by the curved surface of separation roller 54 and is adhered to fixing belt 53 is separated from fixing belt 53 by the separation plate.

Separation roller 54 is formed by a member such as ceramics. Ceramics used as a member of separation roller 54 have, for example, a volume density of 0.7±0.1 g/cm and a porosity of 69 to 77%. Separation roller 54 must separate a paper fixed by the curvature of the roller portion thereof from fixing belt 53.

Therefore, the diameter of the roller portion of separation roller 54 is designed so as to be smaller than at least the diameter of the roller portion of heat roller 51.

By use of the aforementioned constitution, in fixing device 50, heat roller 51 is driven by a driving means not shown in the drawing and press roller 52, fixing belt 53, and separation roller 54 are driven by the rotation of heat roller 51.

Next, the mechanism of the neighborhood of separation roller 54 will be explained.

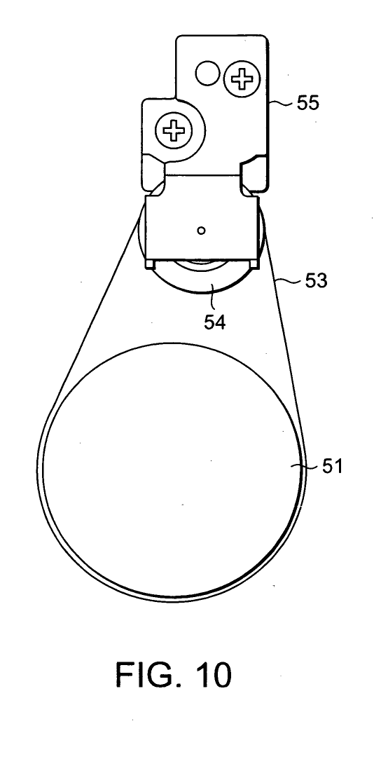

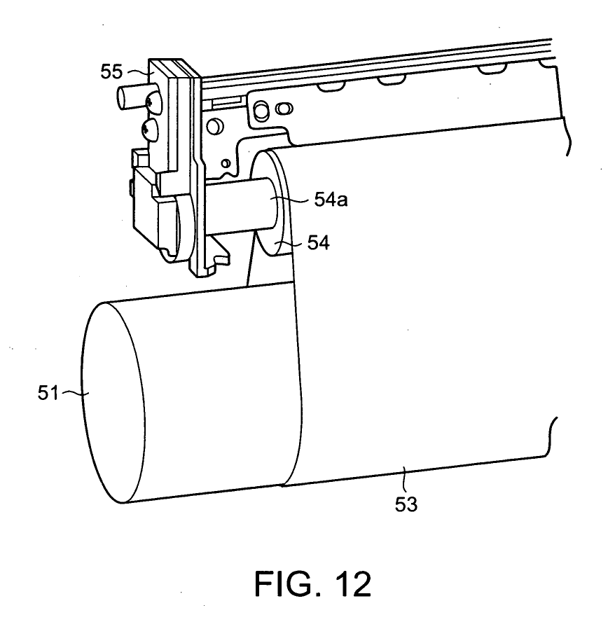

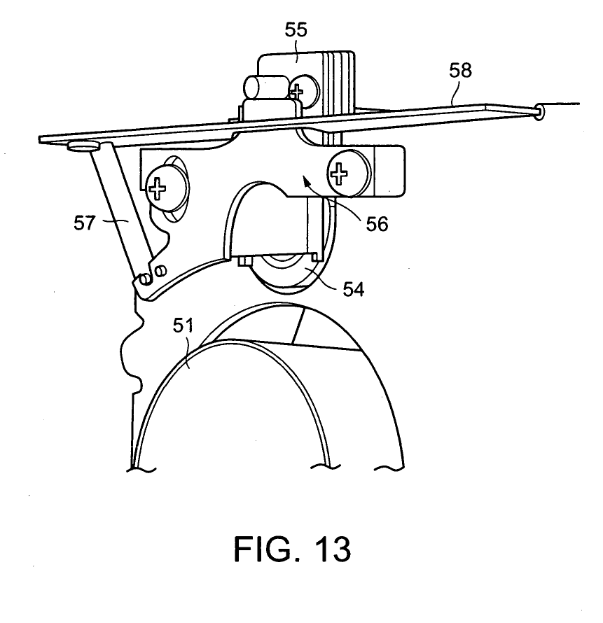

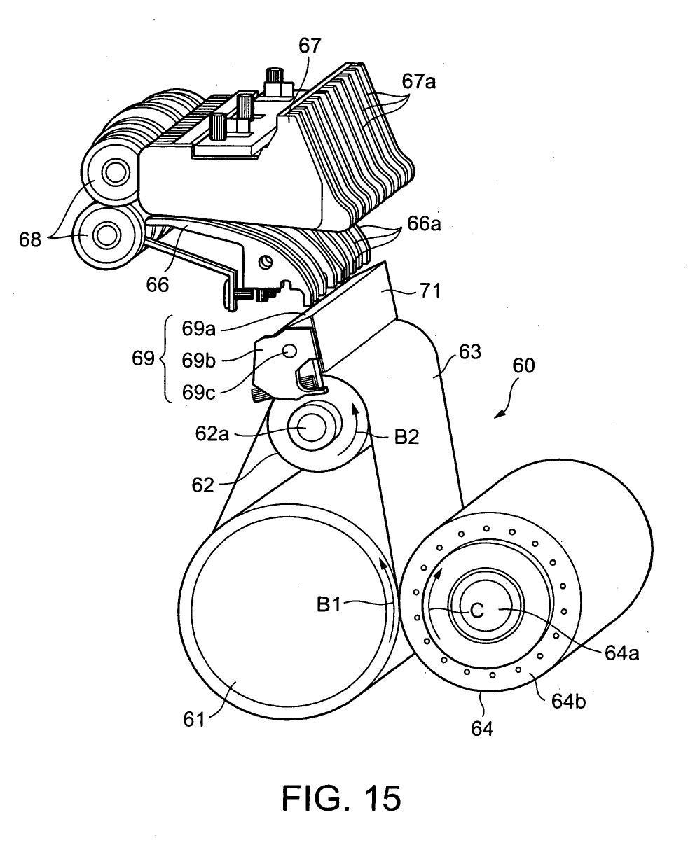

FIGS. 10 to 13 show the mechanism of the neighborhood of separation roller 54. FIGS. 10 and 15 show the mechanism when separation roller 54 is viewed in the direction of the rotation shaft. Further, FIGS. 12 and 13 show the mechanism of the neighborhood of separation roller 54.

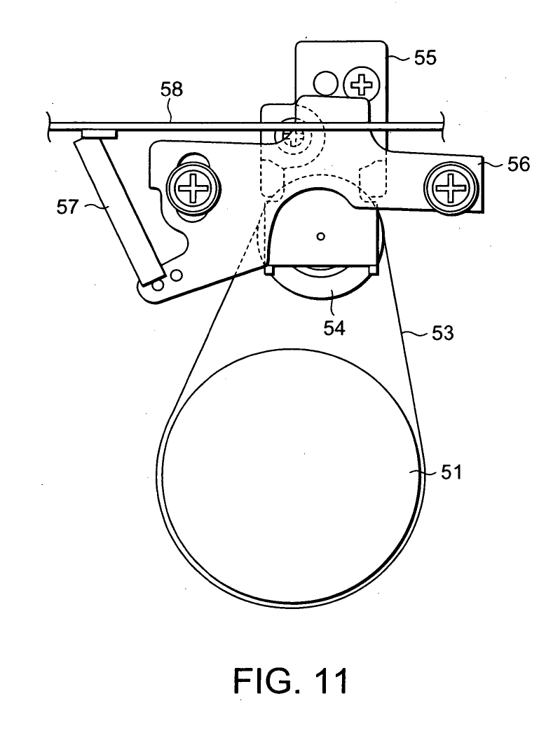

As shown in FIGS. 10 and 12, to shaft 54a of separation roller 54, plate 55 is fixed. Furthermore, to plate 55, as shown in FIGS. 11 and 13, movable plate 56 is fixed. Movable plate 56 is given upward force (force in the direction of separating from heat roller 51) by pressing member 57 such as an elastic member.

Pressing member 57, as shown in FIGS. 11 and 13, since the upper end thereof is fixed to frame 58 installed in the main body of the image forming apparatus and the lower end is fixed to movable plate 56, gives upward force to movable plate 56. Further, plate 56 moves up and down according to the force given from pressing member 57. The upward force given to movable plate 56 by pressing member 57 is transmitted to shaft 54a of separation roller 54 via fixing plate 55. Namely, to separation roller 54, force in the direction (in FIGS. 10 to 13, upward force) of separating from heat roller 51 is given by a pressing mechanism having fixing plate 55, movable plate 56, and pressing member 57.

Next, the relationship between fixing belt 53 and separation roller 54 will be explained.

As mentioned above, fixing belt 53 is stretched by separation roller 54 and heat roller 51 which are pressurized by the aforementioned pressing mechanism. Here, assuming that the position of heat roller 51 is fixed, the force given to fixing belt 53 is force to be given to separation roller 54 by the pressing mechanism.

When large force is given to separation roller 54 by the pressing mechanism, strong force is applied to fixing belt 53, so that damage may be caused to fixing belt 53. Therefore, the force stretching fixing belt 53 must be within a predetermined tolerance. However, when the force stretching fixing belt 53 is excessively weak, the resistance between fixing belt 53 and separation roller 54 is reduced and it becomes highly probable that the surface of separation roller 54 and the inner surface of fixing belt 53 slide. Therefore, the force given to separation roller 54 is set at about 2 to 3 kg.

By use of the aforementioned constitution, separation roller 54 and fixing belt 53 are held by the pressure given by the pressing mechanism and the static friction coefficient between the surface of separation roller 54 and the inner surface of fixing belt 53. On the other hand, in heat roller 51 and fixing belt 53, by the aforementioned stretching force for fixing belt 53 and moreover the pressure given from press roller 52, the surface of heat roller 51 and the inner surface of fixing belt 53 are pressed.

The force given to the nip portion of fixing belt 53 on heat roller 51 by press roller 52, as mentioned above, is extremely larger the force given to separation roller 54. For example, the force given to separation roller 54 is about 2 to 3 kg, while the force pressurized by press roller 52 is about 10 times such as about 20 kg.

Furthermore, the diameter of heat roller 51 is larger than the diameter of separation roller 54. Namely, the size of the contact face of the surface of heat roller 51 and the inner surface of fixing belt 53 is larger than the size of the contact face of the surface of separation roller 54 and the inner surface of fixing belt 53.

According to this, when heat roller 51 is driven by the driving means, even if the surface of heat roller 51 is smooth, the surface of heat roller 51 and the inner surface of fixing belt 53 slide little.

On the other hand, when heat roller 51 is driven by the driving means, separation roller 54 follows heat roller 51 by fixing belt 53. The factors for holding separation roller 54 and fixing belt 53 free of sliding are the force given to separation roller 54 in the direction of separating from heat roller 51, the surface resistance between the surface of separation roller 54 and the inner surface of the belt, and the diameter (the size of the contact face between the surface of separation roller 54 and the inner surface of the belt) of separation roller 54.

As mentioned above, the force given to separation roller 54 in the direction of separating from heat roller 51, to prevent fixing belt 53 from damage, cannot be increased beyond a predetermined tolerance. Further, the diameter of separation roller 54, to maintain the function for separating a paper from fixing belt 53, is preferably as small as possible, so that it cannot be increased.

Therefore, fixing device 50, when heat roller 51 is driven, to prevent separation roller 54 and fixing belt 53 from sliding, is designed so as to make the surface of separation roller 54 rough and increase the surface resistance between the surface of separation roller 54 and the inner surface of fixing belt 53.

For example, the surface of separation roller 54, as mentioned above, is made rougher than the inner surface of fixing belt 53 formed by a metal such as nickel. Further, separation roller 54 is formed by ceramics as mentioned above, thus the surface thereof can be made rough. Further, separation roller 54 is formed by ceramics, thus the warm-up time of fixing device 50 can be shortened. The reason is that ceramics have a heat capacity smaller than that of a metal such as aluminum.

As mentioned above, in fixing device that the belt is held by heat roller 51 and separation roller 54 and separation roller 54 follows heat roller 51, the roughness of the surface of separation roller 54 is made larger than that of the inner surface of fixing belt 53 and the surface resistance between the surface of separation roller 54 and the inner surface of fixing belt 53 is increased.

By doing this, the resistance of the contact face between the surface of the separation roller and the belt can be increased, and the separation roller can surely follow the heat roller, and the separation roller and belt can efficiently follow.

Further, the separation roller is made of ceramics, thus the warm-up time of the fixing device can be shortened, and the resistance of the contact face between the surface of the separation roller and the belt can be increased, and efficient driving of the fixing device can be realized.

Next, the relationship between heat roller 51, fixing belt 53, and separation roller 54 will be explained.

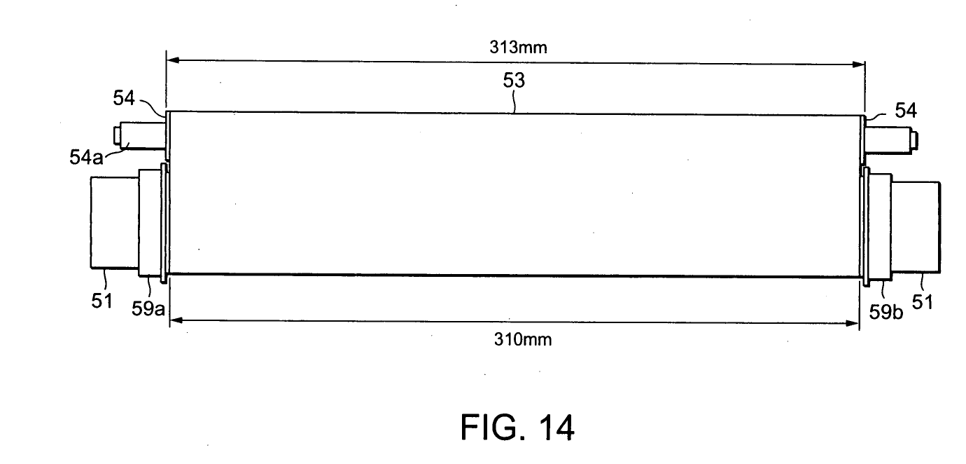

FIG. 14 shows the relationship between heat roller 51, fixing belt 53, and separation roller 54.

In the example shown in FIG. 14, the width of fixing belt 53 is 310 mm, and the width of separation roller 54 is 313 mm, and the width between belt guide portions 59a and 59b of heat roller 51 is 313 mm.

The width of fixing belt 53 is designed according to the size of a paper as an image formed medium to be fixed by fixing device 50. Namely, in fixing device 50, the width of fixing belt 53 is designed so as to be larger than the maximum paper size to be fixed. For example, in the example shown in FIG. 14, as a maximum paper size to be fixed, papers of 304 mm are supposed and an allowance of about 6 mm is provided for the maximum paper size.

The reason is that there is the possibility that a horizontal displacement may occur in papers supplied to the nip portion between press roller 52 and fixing belt 53. Therefore, the width of fixing belt is designed on the basis of the horizontal displacement range supposed as the size of the maximum size of papers. In the example shown in FIG. 14, an allowance of about 3 mm is provided in the transverse direction and within this range, for the maximum size of papers, a stable fixing process can be realized.

Further, the width of separation roller 54 and the width between the belt guide portions of heat roller 51 are designed according to the width of fixing belt 53. Namely, in fixing device 50, the width of separation roller 54 and the width between the belt guide portions of heat roller 51 are designed so as to be wider at least than the width of fixing belt 53 and for example, in the example shown in FIG. 14, the width of fixing belt 53 is designed as 310 mm, so that an allowance of about 3 mm is provided for the width of the belt.

The reason that the width of separation roller 54 is made larger than the width of the belt is that the end portion of fixing belt 53 is protected. Namely, when fixing belt 53 is shifted and the end portion of fixing belt 53 reaches the end of separation roller 54, large force is applied to the portion, thus fixing belt 53 may be ruptured due to fatigue.

Therefore, the width of separation roller 54 may be a width for surely supporting both ends of fixing belt 53 and may be wider than the width of fixing belt 53. Further, as shown in FIG. 14, when belt guide portions 59a and 59b are installed on heat roller 51, the width of separation roller 54 may be equal to the width between belt guide portions 59a and 59b of heat roller 51 or may be wider than the width between belt guide portions 59a and 59b of heat roller 51.

For example, in the example shown in FIG. 14, the width of separation roller 54 is equal to the width between belt guide portions 59a and 59b of heat roller 51, though the width of separation roller 54 may be wider than the width between belt guide portions 59a and 59b of heat roller 51.

As mentioned above, in fixing device 50, the width of the separation roller is wider than the width of the belt designed on the basis of the size of the maximum size of papers. By doing this, at the end portion of the separation roller, the end of the belt can be prevented from fatigue rupture.

Further, when the width of the separation roller is made equal to or wider than the width between the belt guide portions installed on the heat roller, the whole belt can be surely supported by the separation roller and the belt can be prevented from a fault such as fatigue rupture.

Next, the third embodiment of the fixing device of the present invention will be explained.

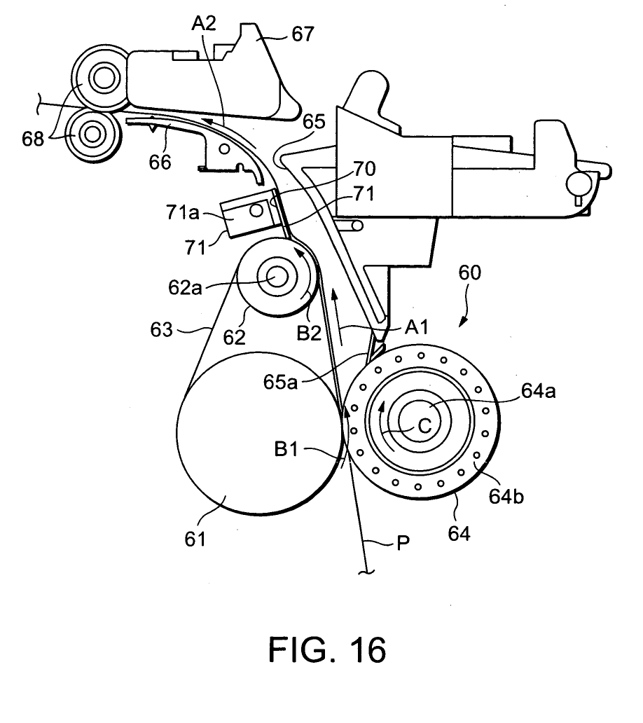

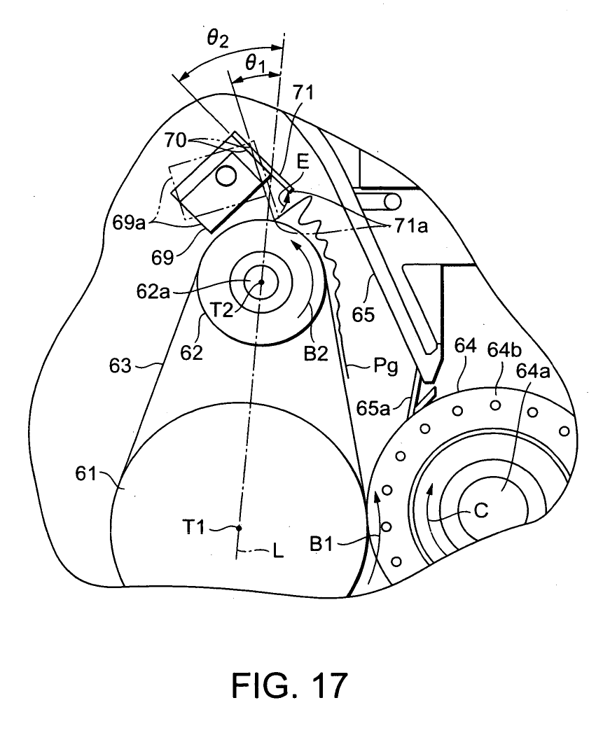

In FIG. 15, first conveying guide 65 which will be described later is omitted and in FIGS. 16 and 17, hinge member 20b that will be described later is omitted.

In fixing device 60 shown in FIG. 15, paper P as a sheet-like recording medium on which a toner image is transferred passes between heat roller 61 and press roller 64, thus the toner image is fixed to paper P.

Fixing device 60 of this embodiment has heat roller 61 whose outer peripheral surface is at least heated, separation roller 62 for separating paper P from heat roller 61, fixing belt 63 stretched between heat roller 61 and separation roller 62, press roller 64 for pressing heat roller 61, support member 69 installed rotatably in the neighborhood of separation roller 62, and separation plate 71 supported by support member 69.

As heat roller 61, for example, a one which is structured so that a heater lamp is inserted as a heat source in a cylindrical member or the outer peripheral surface of the cylindrical member is heated by IH (induction heating) may be used. Heat roller 61 is driven to rotate by a rotation driving unit not shown in the drawing in the direction of arrow B1 shown in the drawing.

Separation roller 62 is arranged in the neighborhood of heat roller 61. In this embodiment, separation roller 62 is arranged, for example, above heat roller 61. From both ends of separation roller 62, shafts 62a (only shaft 3a extending from one end is shown in FIGS. 15 to 17) are extended and shafts 62a are born rotatably by bearings not shown in the drawing. Between separation roller 62a and heat roller 61, fixing belt 63 is stretched. The rotation of heat roller 61 is transferred to separation roller 62 via fixing belt 63, so that separation roller 62 follows the rotation of heat roller 61 and rotates in the direction of arrow B2 shown in the drawing.

Press roller 64 has rotary shaft 64a and elastic member 64b installed so as to cover the outer periphery of rotary shaft 64a.

Elastic member 64b may use, for example, a sponge made of synthetic resin. Press roller 64 is installed so as to press heat roller 61. Rotary shaft 64a is born rotatably by a bearing not shown in the drawing. Press roller 64 is driven to rotate at a predetermined speed by a rotation driving unit not shown in the drawing in the direction of arrow C shown in the drawing, that is, in the opposite direction of the rotational direction of heat roller 61. Rollers 61, 62, and 64 are respectively formed almost in the same length so as to be slightly wider than the width of papers P.

In the neighborhood of separation roller 62, support member 69 is installed rotatably. More in detail, support member 69 has elongated member 69a, a pair of hinge members 69b (in the drawing, only hinge member 20b installed on one side is shown), and cylindrical hinge clasp 69c. Elongated member 69a is formed in a long and narrow shape in the longitudinal direction of separation roller 62. Elongated member 69a has flat surface 70 and a through hole (not shown in the drawing) formed in the longitudinal direction through which hinge clasp 69c passes. Paired hinge members 69b are installed on both sides of elongated member 69a and are fixed to, for example, a stay (not shown in the drawing) for supporting fixing device 60. Elongated member 69a is attached rotatably to paired hinge members 69b via hinge clasp 69c.

In this embodiment, as shown in FIG. 17, flat surface 70 of elongated member 69a, in the ordinary state, is supported by paired hinge members 69b so as to incline by initial angle θ1 with straight line L connecting center T1 of heat roller 61 and center T2 of separation roller 62. Further, elongated member 69a is installed rotatably in the direction in which flat surface 70 forms predetermined angle θ2 larger than initial angle θ1 with straight line L.

Separation plate 71, as shown in FIG. 15, is formed in a long and narrow shape in the longitudinal direction of separation roller 62. Separation plate 71 can use a plate member, for example, formed by stainless steel. The thickness of separation plate 71 is, for example, about 0.2 mm to 0.5 mm.

As shown in FIG. 17, separation plate 71 is attached so that one side thereof makes contact with flat surface 70 of elongated member 69a. At this time, separation plate 71, when elongated member 69a is in the state of initial angle θ1, is attached in the neighborhood so that the gap between end face 71a and fixing belt 63 becomes about 0.4 mm to 0.5 mm. Further, in the ordinary state, flat surface 70 of elongated member 69a is inclined at initial angle θ1 with straight line L. Therefore, the side of separation plate 71, in the ordinary state, is also inclined at initial angle θ1 with straight line L.

Therefore, separation plate 71 is arranged so that the square portion formed by end surface 71a and one side in contact with flat surface 70 of elongated member 69a approaches in the neighborhood of the top of separation roller 62 on which fixing belt 63 is stretched.

Further, separation plate 71 rotates between initial angle θ1 and predetermined angle θ2 in connection with support member 69. Namely, separation plate 71 is supported by support member 69 and freely rotates between the proximity position where end face 71a approaches fixing belt 63 and the shift position where end face 71a is shifted so as to separate from fixing belt 63 farther than the proximity position.

In the ordinary paper conveying shown in FIG. 16, paper P makes contact with the other side opposite to one side in contact with flat surface 70 of elongated member 69a of separation plate 71. Therefore, in separation plate 71, force is applied to the other side toward the left in FIG. 16. On the other hand, separation plate 71 is positioned so as not to rotate in the direction that the end makes contact with the surface of separation roller 62 beyond the position of initial angle θ1 (clockwise in FIG. 16). Therefore, in the ordinary paper conveyor path, the end of separation plate 71 will not move to the left in FIG. 16 beyond initial angle θ1.

On the other hand, as shown in FIG. 17, when a paper jam occurs, jammed paper Pg makes contact with end surface 71a of separation plate 71. And, jammed paper Pg is clogged, thus end surface 71a of separation plate 71 is pressed. By doing this, separation plate 71 rotates in the direction of increasing the angle from initial angle θ1 (counterclockwise in FIG. 17). Namely, in this embodiment, separation plate 71, only when force is applied to end surface 71a, rotates so that the end thereof moves to the right in FIG. 17.

In the drawing, numeral 65 indicates a first conveying guide, 66 a second conveying guide, 67 a third conveying guide, and 68 a pair of exit rollers.

First conveying guide 65 is formed in the longitudinal direction of press roller 64. In first conveying guide 65, one edge side is positioned above press roller 64 and is curved so as to cover separation roller 62 and the other edge side extends above support member 69. Namely, first conveying guide 65 is arranged so as to partially cover fixing belt 63, separation roller 62, and support member 69. Further, first conveying guide 65 has a plurality of separation claws 65a (only one is shown in FIGS. 16 and 17) at one edge thereof, which are installed so that the end portion of each of them makes contact with press roller 64. Separation claws 65a are arranged in the longitudinal direction of press roller 64 so as to be separated from each other. The end portions of separation claws 65a are formed in a knife-edge shape.

In second conveying guide 66, for example, a plurality of plate members 66a made of a metal in almost the same shape are arranged in the longitudinal direction of separation roller 62 so as to be separated from each other. In second conveying guide 66, that is, the plurality of plate members 66a, one edge side is positioned above the support member and is curved so as to approach horizontally and the other edge side is formed so as to approach the exit roller. In third conveying guide 67, for example, a plurality of plate members 67a made of synthetic resin in almost the same shape are arranged in the longitudinal direction of separation roller 62 so as to be separated from each other. Third conveying guide 67, that is, the plurality of plate members 67a are arranged so as to be opposite to second conveying guide 66.

Fixing device 60 structured as described above operates as indicated below. Heat roller 61 rotates in the direction of arrow B1 shown in the drawing and press roller 64 rotates in the direction of arrow C shown in the drawing. Therefore, paper P led from underneath between heat roller 61 and press roller 64 for pressing heat roller 61 is conveyed upward as indicated by arrow A1 in FIG. 16. In the ordinary state, separation plate 71 is positioned at the proximity position where end surface 71a approaches fixing belt 63, so that paper P which is led between fixing belt 63 and first conveying guide 65 by fixing belt 63 and is conveyed to separation roller 62 is separated from fixing belt 63 by separation plate 71 in the neighborhood of the top where fixing belt 63 of separation roller 62 is stretched. And, as shown by arrow A2 in FIG. 16, paper P moves upward along separation plate 71, passes between second conveying guide 66 and third conveying guide 67, and is led and ejected by a pair of exit rollers 68.

Further, as shown in FIG. 17, when a jam occurs in the neighborhood of the end of separation plate 71, jammed paper Pg may make contact with end surface 71a of separation plate 71. Furthermore, when separation roller 62 is driven to rotate in this state, jammed paper Pg pushes up end surface 71a of separation plate 71 from underneath. When the pressure (pushing force from jammed paper Pg) is applied to end surface 71a like this, end surface 71a, as shown by arrow E in FIG. 17, rotates toward the shift position where it is shifted so as to be separated from fixing belt 63 farther than the proximity position. Therefore, separation plate 71 is prevented from deformation and damage due to the pressure from jammed paper Pg.

As mentioned above, according to fixing device 60 of the third embodiment, separation plate 71 is supported by support member 69 so as to freely rotate between the proximity position where end surface 71a approaches fixing belt 63 and the shift position where when the pressure is applied to end surface 71a, end surface 71a is shifted in the direction of separating it from the belt farther than the proximity position. Therefore, even if jammed paper Pg makes contact with end surface 71a of separation plate 71 and pushes it up, separation plate 71 can be shifted in the direction of separating from the outside surface of separation roller 62. Therefore, separation plate 71 can be prevented from deformation and damage.

According to the present invention, a fixing device capable of preventing the rollers from scratching or damage can be obtained.

Further, according to the present invention, when a paper jam occurs in the fixing device in the apparatus or in the neighborhood thereof, jammed paper can be removed simply.

Furthermore, according to the present invention, a fixing device capable of driving each unit in the fixing device surely and efficiently can be provided. Further, a fixing device capable of holding a satisfactory relationship between the fixing belt, separation roller, and heat roller and suppressing the generation rate of faults such as damage of the belt can be provided.

According to the present invention, a fixing device capable of preventing the separation plate from deformation and damage can be obtained.

1. A fixing device, comprising:
a heat roller whose outer peripheral surface is at least heated;
a press roller configured to press the heat roller;
at least one separation claw having a rotation central shaft provided at a first end portion thereof and a second end portion on the opposite of the first end portion, wherein the second end portion is provided touchably on an outer peripheral surface of either of the heat roller and the press roller, and the second end portion makes contact with the outer peripheral surface of the roller, thus the recording medium is separated from the roller; and
a support member configured to rotatably support the rotation central shaft and lead the rotation central shaft to make the second end portion separate from the roller when pressing force is applied for the second end portion to make contact with the roller.

2. The fixing device according to claim 1, wherein a plurality of the separation claws are provided and the separation claws are supported by the support member so as to operate independently.

3. The fixing device according to claim 1, wherein the separation claw is provided touchably with the outer peripheral surface of the press roller.

4. The fixing device according to claim 3, wherein hardness of the outer periphery of the press roller is set at ASKER C 55 or lower in the SRIS 0101 spring type ASKERC model.

5. The fixing device according to claim 3, wherein a movement position of center of the rotation central shaft when the second end portion of the separation claw is shifted in the direction of separating from the press roller is set on a straight line parallel with a tangent passing the centers of the rotation central shafts and passing a point of tangency of the second end portion of the separation claw and the outer peripheral surface of the press roller, or on a horizontal line passing the center of the rotation central shaft, or within a range held by the straight line parallel with the tangent and the horizontal line.

6. The fixing device according to claim 3, further comprising a stopper configured to suppress the second end portion of the separation claw from passing a predetermined position and moving in a direction of pressing inside the press roller.

7. The fixing device according to claim 6, wherein by a reaction from the stopper generated when the separation claw makes contact with the stopper, to move the separation claw in a direction of separating from the press roller, positions and shapes of the separation claw and the stopper are respectively set.

8. An image forming apparatus to form an image on a surface of a paper conveyed in a conveyor path, comprising:
a guide unit having a guide face to guide the paper; and
a separation member that is provided in the guide unit projectably from the guide face, projects into the conveyor path from the guide face, thereby separates the paper from the guide face.

9. The image forming apparatus according to claim 8, wherein the guide face is a curved face having a center of curvature on the opposite side of the conveyor path.

10. The image forming apparatus according to claim 8, wherein the separation member enters the guide unit up to the position where the separation member is flush with the guide face.

11. The image forming apparatus according to claim 8, wherein the separation member completely enters the guide unit.

12. An image forming apparatus, comprising:
a conveyor path configured to convey a paper on which an image is formed; and
a rise and fall member for during conveying the paper, guiding the paper which is pushed down and conveyed in the conveyor path, and when the paper is jammed, is raised on a conveyor path side, thereby loosens the paper in the conveyor path.

13. A fixing device, comprising:
a heat roller heated by a heat source;
a separation roller arranged in the neighborhood of the heat roller;
a fixing belt supported in a state that the fixing belt is stretched between the heat roller and the separation roller; and
a press roller in contact with the heat roller at a predetermined pressure across the fixing belt,
wherein the heat roller is driven by driving means, and the separation roller, the fixing belt, and the press roller follow the heat roller driven by the driving means, and a surface of the separation roller is rougher than a contact face of the fixing belt.

14. The fixing device according to claim 13, wherein the fixing belt is formed by a metallic member and the separation roller is formed by a member which has a small heat capacity and whose surface is finished at predetermined roughness.

15. The fixing device according to claim 14, wherein the separation roller is formed by ceramics.

16. A fixing device, comprising:
a heat roller heated by a heat source;
a separation roller arranged in the neighborhood of the heat roller;
a fixing belt supported in a state that the fixing belt is stretched between the heat roller and the separation roller; and
a press roller in contact with the heat roller at a predetermined pressure across the fixing belt,
wherein a width of the separation roller is wider than a width of the fixing belt.

17. The fixing device according to claim 16, wherein on the heat roller, guide units to guide both ends of the fixing belt are provided and a width of the separation roller is equal to or wider than an interval between the guide units of the heat roller.

18. A fixing device, comprising:
a heat roller whose outer peripheral surface is at least heated;
a press roller to press the heat roller;
a separation roller arranged opposite to the heat roller;
a fixing belt stretched between the heat roller and the separation roller;
a support member provided rotatably in the neighborhood of the separation roller; and
a separation plate which has an end surface and is supported by the support member so as to freely rotate between a proximity position where the end surface approaches the fixing belt and a shift position where when the end surface is pressed, the end face is shifted so as to separate from the fixing belt farther than the proximity position.
